(19) United States
(12) Patent Application Publication
(10) Pub. No.: US 2009/0321605 A1
(43) Pub. Date: Dec. 31, 2009

(54) Laptop Stand

(76) Inventor: Scott Petrie, Toronto (CA)

Correspondence Address: Scott Petrie, 37 Indian Rd., Toronto, M6R 2V2, omitted

(21) Appl. No.: 12/146,681

(22) Filed: Jun. 26, 2008

(51) Int. Cl. F16M 11/22; A47B 97/02

(52) U.S. Cl. 248/452; 248/176.1

(57) ABSTRACT

The EZ Laptop Stand® is a stand for a laptop computer that is very inexpensive, extremely lightweight, easy to assemble and disassemble and folds flat for portability. It is made from foamcore for its light weight, inexpensive material cost, and strength and durability when designed in the manner that it is. Manufacturing is done by laser cutting or die cutting, both methods being cost effective and practical for use with foamcore. There are three models of the EZ Laptop Stand®, the main feature of all three consisting of primary support members, which when folded or hinged at an acute angle at their mid point, create two strong triangular sloped surfaces tapered to a narrower dimension towards the bottom, front edge (the side closest to the user), where feet protrude upward for the laptop computer to rest against. These two primary support members are connected by two smaller cross-members that slide onto them along slots that keep all the pieces of the EZ Laptop Stand® fixed, in a rigid, upright formation on which the laptop computer rests. The EZ Laptop Stand® raises the laptop computer high enough to achieve proper ergonomics for the user while allowing comfortable use of onboard keyboard, high enough to allow adequate ventilation for heat dissipation from under the computer, high enough to provide protection from spilled of beverages, and is inexpensive to buy and simple to disassemble and reassemble for easy portability.

The EZ Laptop Stand® is made in 3 different designs called Model A, Model X, and Model U. Model A and Model X are for use on a desktop surface, under any laptop computer, but each one is designed to better accommodate slightly different configurations of laptop computers. Model U is for using a laptop computer while sitting or lying down when the user wishes to use it directly on their lap.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to laptop computer stands which are used to support laptop computers or any electronic device or book that benefits from being held up off of a desk surface or a users lap at a angle facing towards the user.

Since the introduction of the laptop computer, users have had the convenience of having a portable computer that can be carried around, opened and used wherever they want. This however has required the user to rest their laptop computers on either a desk or table surface, or their laps which creates in the user an angle of view that is downward the a degree that causes neck and shoulder strain over extended periods of time. Also the physical dimensions of laptop computers prevent the heat generated from the electronic components from dissipating well enough and heat buildup has become an issue that effects the lifespan of the internal components and in some cases has even become a safety issue due to fire hazard. The most noticeable drawback of this heat buildup inside a laptop computer's CPU is the heat exposure suffered by the user when it is used on his or her lap, which does, in most models, become far too excessive to enable extended use.

In regards to ergonomics, it has been known since the dawn of computers that proper ergonomic positioning of a computer screen requires that the top of the screen be as close to level with the users eye as possible so that the user can hold their head in neutral position and therefore look comfortably at the screen for extended periods of time. With a laptop computer resting on a desktop surface the screen is much lower than this making it necessary for the user to have their head tilted downward to a degree that causes strain in the muscles at the back of the neck especially with periods of continuous, repetitive use. Most users do not perceive this strain until it has caused adverse effects in other connective tissues and bones of the upper back and shoulders causing indirectly related muscle strain in those areas as well.

There have, as a result, been a number of stands created for laptop computers since they became popular, all of which have a number of disadvantages based on their design. In spite of the current proliferation of designs available in the laptop computer stand market, none have been able to capture more than a small market size relative to the potential that exists. It is the disadvantages inherent in the design of these existing laptop computer stands that is responsible for their inability capture a significant market among laptop computer users. Those disadvantages are listed as follows:

(a) A primary deterrent for laptop computer users to purchase many of the existing laptop computer stands is in their price. Being manufactured mainly from either injection molded plastic or molded and machined metal makes them expensive to manufacture and therefore expensive to buy for the average consumer of a laptop computer.

(b) The next prominent deterrent is the lack of portability of most of the existing laptop computer stands. Either due to sheer size or a level of complexity in their design and construction and an inability to fold up quickly, and small, almost all other laptop computer stands do not to live up to the ‘portable’ nature of laptop computers, which they are designed for, making them useful (to the degree that they are) in only one primary location. The lack of portability also can multiply the cost deterrent for users who as a result have a need to buy more than one laptop stand.

(c) The third, and possibly the most significant deterrent is that many of the existing stands on the market do not raise the user's laptop computer high enough to permit an ergonomically correct head and neck position for the user, or on two other unrelated points, to ventilate the bottom of the CPU enough to dissipate heat buildup, or to keep the onboard keyboard, plugs and receptacles out of hazard from spilled beverages.

Many laptop computer stands on the market claim to dissipate heat buildup under a laptop computer but provide inadequate space beneath the laptop computer to significantly improve air circulation. And any laptop computer stand that does not bring the laptop computer up to optimal height prevent these hazards does not provide the prime advantage of a computer laptop stand, proper ergonomics for the user. And many laptop computer stands that do raise the screen level up to a height that provides proper ergonomics do so in a way that prevents the user from using the onboard keyboard, necessitating the use of a secondary keyboard which although does aid in providing optimum ergonomics, creates another deterrent in terms of portability.

2. Prior Art

In many existing designs or designs for which there are patents, there are multiple features detrimental to their success and in others, the minimization of one detrimental feature is at the maximization of the others to the point where there is not one existing design that has insignificant negative factors. It is these negative factors that have prevented all predecessors in the laptop stand market from achieving a significant market share, that as a result, has a large untapped potential. Informal inquiry regarding this potential market size through empirical survey of a range of computer retailers suggests that on average, the percentage of laptop computers that are used without a stand is in the range of 85-95% of the laptop computers in circulation.

In researching the prior art, none of the following laptop computer stands for which there have been patents granted, (ref. U.S. Pat. No. 6,505,797, No. D554,647, No. 7,038,906, No. D475,057, No. 6,076,787, No. 6,352,233, No. 5,295,089, No. 6,545,864, No. 6,208,508, No. 6,266,241) bear a close resemblance to the design of the EZ Laptop Stand®. They all fall short of keeping the previously mentioned negatives (a, b, and c) to a minimum due to their design and that is where the EZ Laptop Stand® sets itself apart from them not only in terms of the physical design but in terms of the advantages vs. disadvantages.

One example of another laptop computer stand that is modular in construction is described in U.S. Pat. No. 6,819,548 (2004). This laptop computer stand will be referred to in the proceeding as '548. The design of the EZ Laptop Stand® differentiates itself from the laptop stand in '548 in it's most basic characteristics. As stated within all of the claims and in it's specifications, the base member for '548 is a ‘substantially flat base member’ that is ‘flexible’ into a ‘curved configuration’. Conversely the sloped primary support members in the EZ Laptop Stand® specifically must be made of a ‘rigid’, non-flexible material, and is ‘folded’, not curved. In fact, flexible material used in the construction of the EZ Laptop Stand® would render it unsafe and similarly compromises the safety of the laptop computer stand described in '548. Also '548 has a limitation in its use, in that it is for supporting a laptop computer only on a flat desktop surface whereas embodiment 3, (model U) of the EZ Laptop Stand® enables it to securely support a laptop computer on a users lap, something that would be precarious with the laptop computer stand described in '548 due to it's construction and shape along the bottom edge of the members. To further highlight the differences between these two laptop computer stands, the substantially flat base member in '548, if it is designed long enough to substantially cover the bottom surface of a laptop computer in the method stated, when disassembled and laid flat, is too long for easy portability inside a computer briefcase or backpack. And in addition to this, even if this main curved member is made as long as it can possibly be, it still lacks substantial support beneath the rear quadrants of any laptop computer, making it far less stable than the design of the EZ Laptop Stand® with it's two (in the preferred embodiments), rigid, folded, sloped primary support members, that securely support any laptop computer at all four main quadrants. The EZ Laptop Stand® in embodiment 1 (model A) and embodiment 2 (model X) comprises two rigid, folded, sloped primary support members, connected by one or two straight cross members, upon which the laptop computer rests, providing a much more secure surface, in contrast to only one flexible, main sloped member in the design described in '548. Any material that is flexible does not provide the security needed to safely support any expensive object. The EZ Laptop Stand®, in contrast, will safely support 25 times the weight of the average laptop computer and has been successfully tested to securely support a 150 lb. adult standing on a piece of plywood the size of a laptop computer.

The wide array of laptop computer stands on the market or for which patents have been granted, all have a number of disadvantages inherent in their design that makes them various combinations of too elaborate or too complicated to use, not high enough for proper computer ergonomics, not portable enough, not ventilating enough or too difficult or expensive to manufacture and sell that it is not surprising that none of them have secured a significant share in a market that has significant needs that have not yet been met.

The EZ Laptop Stand® avoids all of the aforementioned disadvantages while providing a laptop computer stand that also allows a user to comfortably use the onboard keyboard.

### SUMMARY

The EZ Laptop Stand® is a laptop computer stand that is very inexpensive, extremely lightweight, easy to assemble and disassemble and folds flat for portability. Although it can be made from any rigid, sheet material, foamcore is the material of choice due to its light weight, inexpensive material cost, and strength and durability when designed in the manner that it is. Manufacturing is done by laser cutting or die cutting, both methods being cost effective and practical for use with foamcore. The main features of the EZ Laptop Stand® consist of one, two or three primary support members, which, when folded at an acute angle and placed on their edge create strong sloped surfaces tapered to a narrower dimension towards the bottom, front edge (the side closest to the user), where feet protrude upward for the laptop computer to rest against. These sloped primary support members are connected by one or two smaller cross-members, also placed on their edge, that slide onto them along interlocking slots thereby forming a rigid, sturdy structure to support a laptop computer, book or other object that a user might want to keep raised off of a work surface or their lap at a forward tilted angle.

There are three primary embodiments of the EZ Laptop Stand® that are referred to as Embodiment 1 (Model A), Embodiment 2 (Model X), and Embodiment 3 (Model U). Embodiment 1 (Model A) and Embodiment 2 (Model X) are for use on a desktop surface, under any laptop computer, but each one is designed to better accommodate slightly different configurations of laptop computers. Embodiment 3 (Model U) is for using a laptop computer while sitting or lying down when the user wishes to use it directly on their lap.

### DETAILED DESCRIPTION—DRAWING REFERENCE NUMBERS

A list of members with associated numbers are shown below. They are referenced in the descriptions and labeled in the drawings that follow. All members are consistently referred to with the same numbers in all embodiments.
21—sloped primary support member
22—vertical protruding feet
23—slight curvature to upper edge of members
24—holes for ventilation, handles and cords
25—front cross-member
26—rear cross-member
27—interlocking slots
28—radius corners on slots

### DETAILED DESCRIPTION—DRAWING FIGURES

All drawings that follow the descriptions, and are referenced in the descriptions, are listed in the figures shown below, on the pages indicated.

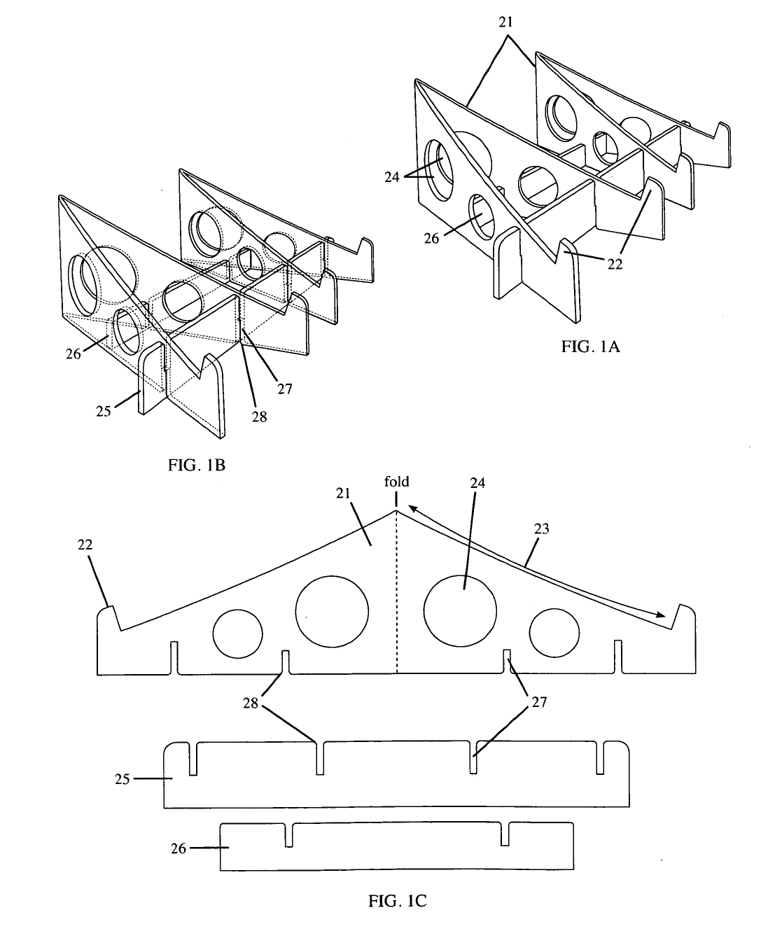

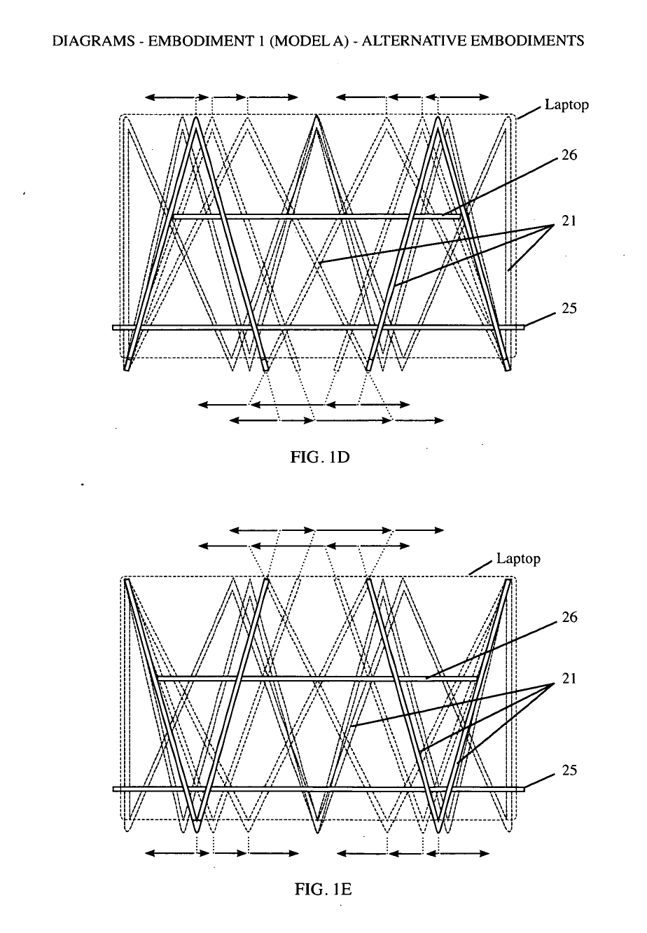

Page 12 . . . FIG. 1A—Embodiment 1 (Model A), Perspective View

FIG. 1B—Embodiment 1 (Model A), Perspective View with Hidden Lines

FIG. 1C—Embodiment 1 (Model A), Dieline of Members, Unfolded and Flat

Page 13 . . . FIG. 1D—Top View of Embodiment 1 (Model A) showing Alternative Embodiments (Variable position of A-shaped or Accordion-shaped Sloped Primary Support Members)

FIG. 1E—Top View of Embodiment 1 (Model A) showing Alternative Embodiments (Variable position of V-shaped or Accordion-shaped Sloped Primary Support Members)

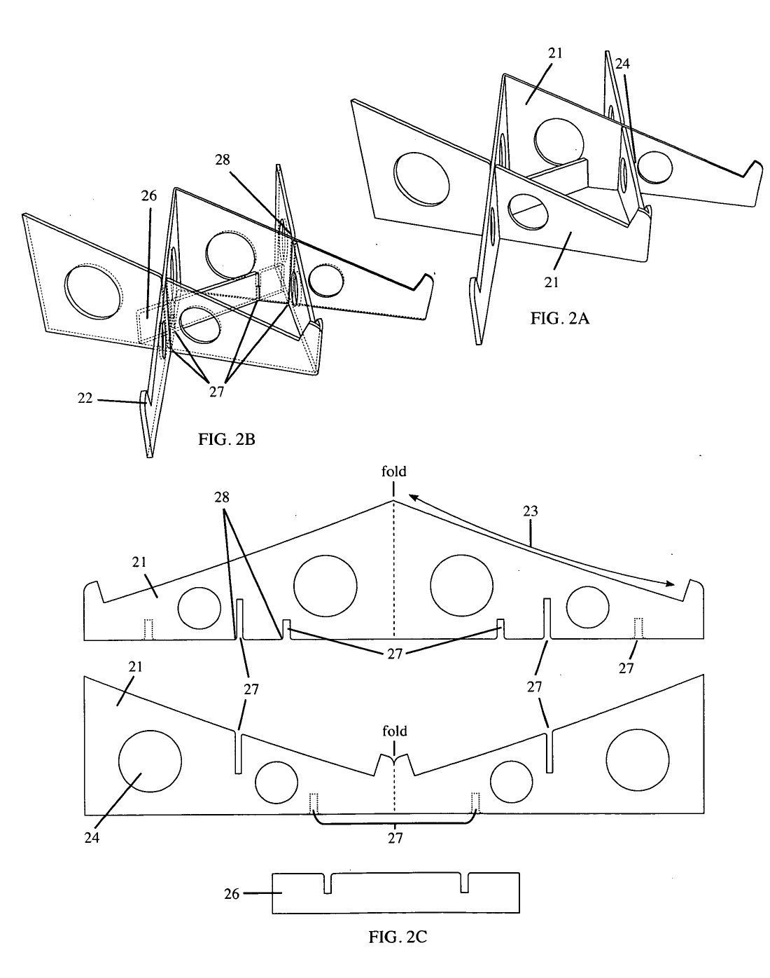

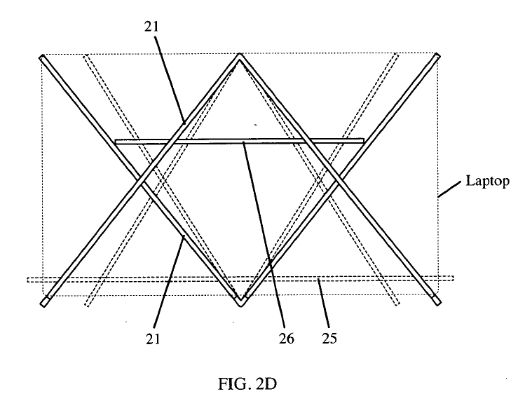

Page 14 . . . FIG. 2A—Embodiment 2 (Model X), Perspective View

FIG. 2B—Embodiment 2 (Model X), Perspective View with Hidden Lines

FIG. 2C—Embodiment 2 (Model X), Dieline of Members, Unfolded and Flat

Page 15 . . . FIG. 2D—Top View of Embodiment 2 (Model X) showing Alternative Embodiments (Variable position of A-shaped and V-shaped Sloped Primary Support Members)

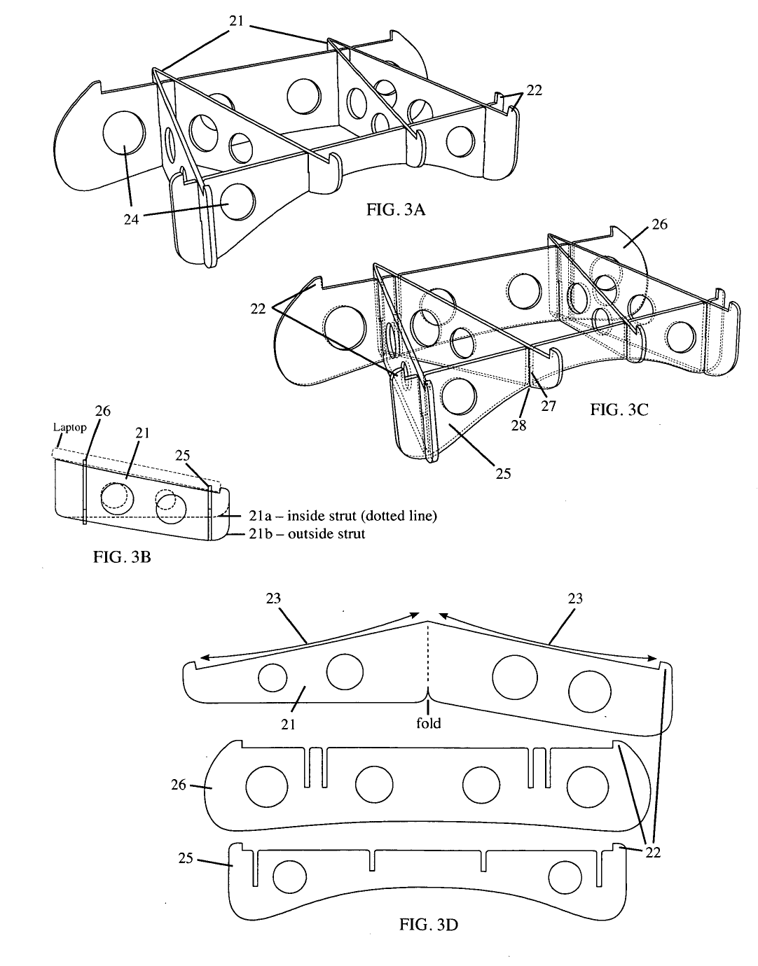

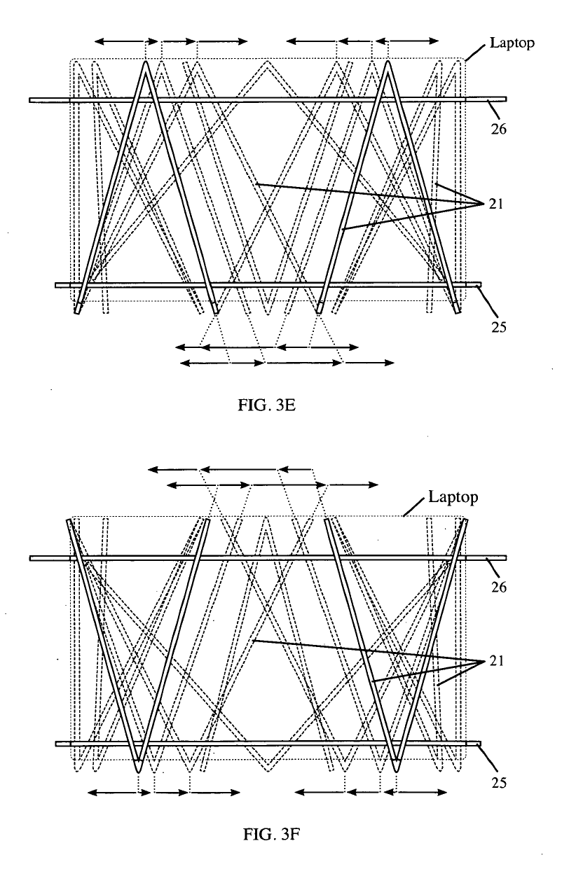

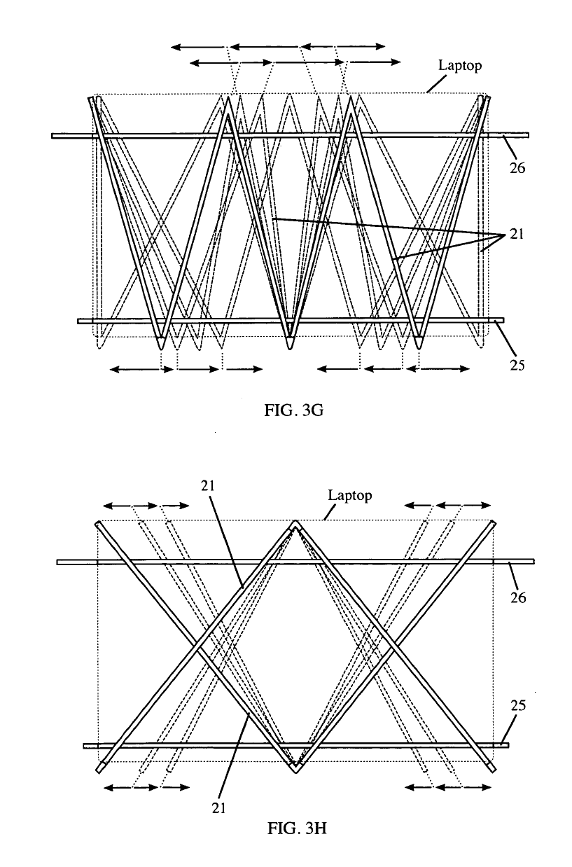

Page 16 . . . FIG. 3A—Embodiment 3 (Model U), Perspective View

FIG. 3B—Embodiment 3 (Model U), Side View, Assembled

FIG. 3C—Embodiment 3 (Model U), Perspective View with Hidden Lines

FIG. 3D—Embodiment 3 (Model U), Dieline Shape of Members, Unfolded and Flat

Page 17 . . . FIG. 3E—Top View of Embodiment 3 (Model U) showing Alternative Embodiments (Dotted lines show variable position of A-shaped and V-shaped Primary Support Members)

FIG. 3F—Top View of Embodiment 3 (Model U) showing Alternative Embodiments (Variable position of V-shaped Sloped Primary Support Members)

Page 18 . . . FIG. 3G—Top View of Embodiment 3 (Model U) showing Alternative Embodiments (Dotted lines show variable position of A-shaped and V-shaped Primary Support Members)

FIG. 3H—Top View of Embodiment 3 (Model U) showing Alternative Embodiments (Dotted lines show variable position of A-shaped and V-shaped Primary Support Members)

### DETAILED DESCRIPTION—EMBODIMENT 1

Embodiment 1 of the EZ Laptop Stand® (called Model A) is illustrated in FIGS. 1A, 1B, 1C, 1D and 1E. The reference numbers used for the parts of this embodiment throughout this description are found on FIGS. 1A, 1B and 1C, on page 14. This embodiment is comprised of two identical sloped primary support members 21, which when folded at their midpoint, creating two struts, and are cut to a narrower dimension towards the end of each strut, and placed on their edge on a desktop surface, create a sloped support upon which the laptop computer rests. These two identical members both have two vertical protruding feet 22, one at the bottom of the slope at the end of each strut, which prevent the laptop computer from sliding forward onto the desk or work surface. These two identical primary support members 21 also have large holes 24 in them to permit increased air flow for added ventilation of the laptop computer, to allow for hand-holds so the laptop computer and laptop stand can be easily picked up and moved around together as a unit, and as a conduit for wires and cables to pass through from one side to the other beneath the laptop computer so the user can keep them neatly organized and out from under the laptop stand when it is moved around from one place to another on a desktop. The upper edge of each strut of both of the sloped primary support members 21, when viewed from the side, is not perfectly straight, but has a very slight concave curvature to it 23, being slightly lower in the centre to accommodate the irregular shaped bottom of some laptop computers. The laptop computer is thus, cradled in the slightly concave upper side of the two sloped members so it rests securely in the EZ Laptop Stand® without any movement. Two rectangular cross-members 25 & 26 complete the assembly by sliding onto these two identical sloped primary support members from the bottom along interlocking slots 27 keeping the laptop stand assembly together in a rigid, upright position to securely hold a laptop computer, book, or other piece of equipment that a person may want to keep raised off of a work surface at a forward-tilted angle. All of the slots 27 on all pieces have small radius corners 28 on their openings for ease of assembly. When assembled this embodiment resembles the shape of two upper-case As, and is therefore called Model A.

There are three different sizes of Embodiment 1 (Model A), one for each of the three different sizes of laptop computers commonly sold. Although the two sloped primary support members of some sizes of the EZ Laptop Stand® can be used with cross-members from any of the other sizes of the EZ Laptop Stand® and will work reasonably well with any of the three sizes of laptop computers commonly used, three distinctly different sizes of all members have been designed to be used together so they better fit each of the three sizes of laptop computers in common usage, in order to be more stable and secure.

Embodiment 1 (Model A) supports the laptop computer along the front at four points (two vertical protruding feet 22 for each of the two identical sloped support members 21) and is therefore better suited to users who require access to the front-center area of their laptop computer where there may be a latch, or plugs and ports that need to be accessed. This embodiment, as with all embodiments, also allows access to the front loading CD/DVD drive found on many laptop computer models.

Different sizes of primary support members 21 and cross-members 25 & 26 could also be created to accommodate much larger or much smaller pieces of equipment. The size of the pieces is not the distinguishing feature but rather the design of the members and how they fit together in all the embodiments indicated in these descriptions.

### DETAILED DESCRIPTION—ALTERNATIVE EMBODIMENTS TO EMBODIMENT 1

Alternative embodiments of Embodiment 1 (Model A) can be designed so that the cross-members slide on from the top of the sloped primary support members, instead of the bottom. As shown in FIGS. 1D and 1E, pg. 15, alternative embodiments can also be designed to have a third sloped primary support member in addition to the two shown. This third sloped support member can be designed to be used in an orientation that makes an A-shape or be designed the other way so it makes a V-shape. Alternatively the two sloped primary support members shown in FIGS. 1A, 1B and 1C can be designed to be oriented the opposite way around so they make a V-shape instead of an A-shape, shown in FIG. 1E, pg. 15. Other alternative embodiments are also shown in FIGS. 1D and 1E, where the sloped primary support members are Accordion-shaped, being formed from one long piece with multiple folds in it.

The dotted lines in FIGS. 1D and 1E show some of the possible variations in the folds and the angles of the A-shaped and V-shaped sloped primary support members. The alternative embodiments of Embodiment 1, shown in FIGS. 1D and 1E and described in these specifications, are numerous based on slight changes in the angle of the folds of the primary support members and the resulting horizontal position of the struts, and are not limited to the exact configurations shown. The EZ Laptop Stand®, Embodiment 1, (Model A), is generally: any rigid, sheet material that when folded, cut on an angle and placed on it's edge, forms two identical sloped primary support members that engage with one or more cross-members, placed on their edge, by sliding onto them along interlocking slots, and thereby forms a rigid, sturdy structure to support a laptop computer, book or other object that a user may want to keep raised off of a work surface at a forward tilted angle.

### DETAILED DESCRIPTION—EMBODIMENT 2

Embodiment 2 of the EZ Laptop Stand® (called Model X) is illustrated in FIGS. 2A, 2B, 2C and 2D. The reference numbers used for the parts of this embodiment throughout this description are found on FIGS. 2A, 2B and 2C on page 16. This model is comprised of two dissimilar shaped primary support members which when folded and placed on their edge, create two struts. The 1st primary support member 21, which is A-shaped when in use is cut to a narrower dimension towards the end of the struts and the 2nd primary support member 21, which is V-shaped when in use, is cut to a narrower dimension towards the fold. Both primary support members, when oriented facing opposite ways, so one forms an A and the other forms a V, and are slid together along interlocking slots 27 and placed vertical on a desktop surface, create a sloped support upon which a laptop computer rests. Both sloped primary support members have a vertical protruding foot 22 at their narrow ends, at the bottom of the slope, which prevents the laptop computer from sliding down onto the desk or work surface. These two different sloped primary support members also have large holes 24 in them to permit increased air flow for added ventilation of the laptop computer, to allow for hand-holds so the laptop computer and laptop stand can be easily picked up and moved around together as a unit, and to allow wires and cables to pass through from one side to the other beneath the laptop computer so the user can keep them neatly organized and out from under the laptop stand when it is moved around from one place to another on a desktop. The upper edge of each strut of both of the sloped primary support members 21, when viewed from the side, is not perfectly straight but has a very slight concave curvature to it 23, being slightly lower in the centre to accommodate the irregular shaped bottom of some laptop computers. The laptop computer is thus, craddled in the slightly concave upper side of the two sloped members so it rests securely in the EZ Laptop Stand® without any movement. One small rectangular cross-member 26 completes the assembly by sliding onto the bottom of the A-shaped, sloped, primary support members, on their rear half along interlocking slots, keeping all pieces in a rigid formation for securely holding a laptop computer book, or other piece of equipment that a person may want to keep raised off a desk surface at a forward tilted angle. All of the slots 27 on all pieces have small radius corners 28 on their openings for ease of assembly. When assembled this model resembles the shape of two Xs, and is therefore called Model X.

There are three different sizes of Embodiment 2 (Model X), one for each of the three different sizes of laptop computers commonly sold. Although the two sloped primary support members of some sizes of the EZ Laptop Stand® can be used with cross-members from any of the other sizes of the EZ Laptop Stand® and will work reasonably well with any of the three sizes of laptop computers commonly used, three distinctly different sizes of all members have been designed to be used together so they better fit each of the three sizes of laptop computers in common usage, in order to be more stable and secure.

Embodiment 2, (Model X) supports the laptop computer along the front at three points (two outside points for the A-shaped, 1st primary sloped support member 21, FIG. 2A, 2B, 2C, and one center point for the V-shaped, 2nd primary sloped support member 21, FIG. 2A, 2B, 2C) and is therefore better suited to users who do not require access to the front-center area of their laptop computer. If this is not a concern for a particular laptop computer user, the choice of whether to use Embodiment 1 (Model A) or Embodiment 2 (Model X) is purely a matter of personal preference. Otherwise they both perform the same function. This embodiment, as with all embodiments, also allows access to the front loading CD/DVD drive found on many laptop computer models.

Different sizes of primary support members 21 and cross-members 25 & 26 could also be created to accommodate much larger or much smaller pieces of equipment. The size of the pieces is not the distinguishing feature but rather the design of the members and how they fit together in all the embodiments indicated in these descriptions.

### DETAILED DESCRIPTION—ALTERNATIVE EMBODIMENTS TO EMBODIMENT 2

Embodiment 2 (Model X) can alternatively be designed to have a second cross member, as an alternative to the one shown, or in addition to it. It will slide onto the bottom edge of the front half of the 2nd primary sloped support member 21 along optional slots 27, FIG. 2C, indicated with dotted lines, instead of the rear half of the 1st primary sloped support member 21 as shown by the slots 27, FIG. 2C, indicated with solid lines. As with the other cross-member it will slide on from below along slots 27 (dotted lines), on FIG. 2C, or as an alternative embodiment, from above, and/or onto both or just one of the sloped members. When sliding onto both sloped members it will be the full width of the EZ Laptop Stand® with four slots in it, looking similar to the front cross-member on Embodiment 1 (Model A). These alternative slots 27, shown with dotted lines on FIG. 2C, will be positioned between the fold and the small holes on the V-shaped, 2nd primary sloped support member 21 and between the protruding foot and the small hole on the A-shaped, 1st primary sloped support member 21 (see 27 on FIG. 2C. pg. 16, fine dotted lines for these slots on the two primary support members).

Other alternative embodiments of Embodiment 2 (Model X) can be designed so that the cross-members slide on from the top of the sloped primary support members, instead of the bottom. As shown in FIG. 2D, pg. 17, Alternative embodiments can have the A-shaped and V-shaped sloped primary support members 21 folded at any angle to span any length of cross-members in order to fit any size or shape of device that it may be used to support. The struts of these A-shaped and V-shaped Sloped primary support members can intersect the cross-members at any point along the cross-members.

The dotted lines on FIG. 2D show some of the possible variations in the folds and the angles of the A-shaped and V-shaped sloped primary support members. The possible alternative embodiments of Embodiment 2, shown in FIG. 2D and described in these specifications are numerous based on slight changes in the angle of the folds of the primary support members and the resulting horizontal position of the struts, and are not limited to the exact configurations shown. The EZ Laptop Stand®, Embodiment 2, (Model X), is generally: any rigid, sheet material that when folded and cut on an angle and placed on it's edge, forms two dissimilar sloped primary support members that engage with each other and with one or more cross-members, also placed on their edge, by sliding onto them along interlocking slots, and thereby forms a rigid, sturdy structure to support a laptop computer, book or other object that a user might want to keep raised off of a work surface at a forward tilted angle.

### DETAILED DESCRIPTION—EMBODIMENT 13

Embodiment 3 of the EZ Laptop Stand (Model U) is illustrated in FIGS. 3A, 3B, 3C, 3D, 3E, 3F, 3G and 3H. The reference numbers used for the parts of this embodiment throughout this description are found on FIGS. 3A, 3B, 3C and 3D on page 18. This embodiment differs from both embodiment 1 (Model A) and embodiment 2 (Model X) in that it is not meant to support a laptop computer on a desk or tabletop surface, but on a users lap while either sitting in a chair or reclining on a bed or couch.

Embodiment 3 (Model U), like Embodiment 1 (Model A), is comprised of two A-shaped sloped primary support members 21 (or three, A-shaped or V-shaped sloped primary support members in other embodiments). These sloped primary support members differ from those in Embodiment 1 (Model A) by being opposite each other in shape (mirror images of each other) in order to fit the shape of a users lap. The two struts, created when these two A-shaped sloped primary support members are folded at their midpoint 21a & 21b, FIG. 3B, have different bottom edge slopes and thus different heights between them and at the front side (the side closest to the user) so they will fit the users lap. Close to the front side they slide onto a front cross-member 25 along interlocking slots 27. This front cross-member 25 is curved on the bottom edge in order to securely fit the front side of most peoples waist, hip or upper legs. A second cross-member 26 slides onto the A-shaped sloped primary support members 21 near the rear side of them, close to the apex of their folding point. The rear cross-member 26 is also shaped on the bottom edge to conform to the front side of the users lap. The height of the struts of the primary support members 21 is the same as the height of the front and rear cross-members 25 & 26 at all points where they intersect, creating a solid bearing upon the front side of a users thigh and hip area. The A-shaped sloped primary support members 21 both have upward protruding feet 22 at the front side (user side) that the laptop computer rests against. Both cross members 25 & 26 also have upward protruding feet 22 at both sides that keep a laptop computer from sliding to the side while the user shifts around while sitting or reclining. As on Embodiment 1 (Model A) and Embodiment 2 (Model X), the sloped primary support members on Embodiment 3 (Model U) also have large holes 24 in them to permit increased air flow for added ventilation of the laptop computer, to allow for hand-holds so the laptop computer and laptop stand can be easily picked up and moved around together as a unit, and to provide a conduit for wires and cables to pass through from one side to the other beneath the laptop computer so the user can keep them neatly organized and out from under the laptop stand when it is moved around from one place to another. The cross-members in Embodiment 3 (Model U) also have large holes in them for the same purpose.

### DETAILED DESCRIPTION—ALTERNATIVE EMBODIMENTS TO EMBODIMENT 3

Alternative embodiments of Embodiment 3 (Model U) can be designed so that the cross-members slide on from the top of the sloped primary support members, instead of the bottom. As shown by the dotted lines in FIGS. 3E and 3F, pg. 19, alternative embodiments can also be designed to have a third sloped support member, in addition to the two explained earlier in this description and shown in FIGS. 3A, 3B, 3C and 3D, pg. 18. This third sloped support member can be oriented to make an A-shape or be designed to fit the opposite way around to make a V-shape. Alternatively the two sloped primary support members 21 shown in FIGS. 3A, 3B, 3C and 3D, pg. 18, can be oriented the other way around so they make a V-shape instead of an A-shape, as shown in FIG. 3F, pg. 19. Other alternative embodiments are shown in FIG. 3H, pg. 20, where the two sloped primary support members are made from one V-shaped and one A-shaped member and slide together facing opposite ways to create the shape of two Xs as with the primary support members of Embodiment 2 (Model X). Further alternative embodiments are shown in FIG. 3G. pg 20, where the sloped primary support member(s) are(is) Accordion-shaped, being formed from one long piece with multiple folds in it.

The possible alternative embodiments of Embodiment 3, shown in FIGS. 3E, 3F, 3G and 3H and described in these specifications are numerous based on slight changes in the angle of the folds of the primary support members and the resulting horizontal position of the struts, and are not limited to the exact configurations shown. The EZ Laptop Stand®, Embodiment 3, (Model U), is generally: any rigid, sheet material that when folded and cut on an angle and placed on it's edge, forms one or more sloped primary support members that engage with one or more cross-members, also placed on their edge, by sliding onto them along interlocking slots, all members having bottom edges shaped to conform to a users lap, and thereby forming a rigid, sturdy structure to support a laptop computer, book or other object that a user might want to keep raised off of their lap at a forward tilted angle.

### DESCRIPTION—ALTERNATIVE EMBODIMENTS TO ALL DESIGNS

Other alternative embodiments of all the embodiments already described, in their method of attaching the members together, can be achieved by having all flat panel sections of any of the three main, assembled embodiments cut out from flat sheets of material and fused together permanently by melting (as with rigid plastic sheeting), or by gluing, as with any rigid sheeting material, or by any other means of fastening. In these alternative embodiments the portability afforded to the embodiments already described (made up of various members that slide together and apart on interlocking slots 27) will be sacrificed, but what will be gained by this type of embodiment, is to some degree an even stronger structure.

Other alternative embodiments of all the embodiments already described, can be achieved by making all points of intersection permanently attached hinges that lock and unlock. The structure could then be folded up and carried around, and unfolded and the hinges locked in position for use. Additional hinge points, which would also lock and unlock, may have to be added to various members to achieve a properly functioning design. In this alternative embodiment the portability of the previously mentioned embodiments will be retained with the added benefit of not having to disassemble and reassemble multiple members, but what will be sacrificed will be inexpensive cost to manufacture and sell the unit.

What is claimed is:

1-31. (canceled)

32. A stand for supporting a laptop computer, said stand comprising:
a. one or two primary support members made from any rigid, sheet material that is (?-plurality) folded, thereby forming a plurality of struts, and
possible next point, said one or two primary support members, that when folded flat are (?-plurality) substantially convex quadrilateral or trapezoid in shape, and
b. said one or two primary support members being placed on their edges so that from above and from the position of the user that said plurality of struts (or—said one or two primary support members) form either the shape of the vertical strokes of the letter A, the letter V. an upper-case N, or the letter W (or a zigzag shape like that of the bellows of an accordion), and
c. said one or two primary support members having an upper edge with a predetermined shape that forms an acclivity (toward the user, when in use) (? or—downward angled slope toward the user, when in use), and
d. said plurality of struts (or—said one or two primary support members) having perpendicular upward protruding feet at the bottom of said acclivity (downward angled slope) to prevent said laptop computer from sliding off of said stand, and
e. said one or two primary support members (or—said plurality of struts) have an upper edge with a concavity to securely hold said laptop computer, and
f. said one or two primary support members (or—said plurality of struts) having a plurality of holes as a means of ventilation, and
a. as a means for hand-holds for (or—grasping with the hands and) moving said stand and said laptop computer as a unit, and
b. as a means for a conduit for cords, to and from both sides, and
g. one or more cross-members made from any rigid, sheet material that are (?-plurality) placed on their (?-plurality) edge, and
h. said one or two primary support members and said one or two cross-members engage with each other, by sliding together along vertically oriented interlocking slots, thereby retaining the members in a fixed assembly; and
i. whereby said fixed assembly forms a rigid structure for supporting said laptop computer that a user wants to keep raised above a surface or above, said users lap.

33. The stand of claim 1 wherein:
a. said one or two primary support members have a flat bottom edge to sit securely on a flat desktop surface, and
b. said one or two primary support members have a dimension at the distal point of said acclivity from the user, when in use, that results in the top of the monitor of said laptop computer being raised to a point 15-18″ above said user's desktop surface, for improved ergonomics, and
c. said one or two primary support members have a dimension at the proximal point of said acclivity from the user, when in use, that results in the front of the main body of said, laptop computer being raised to a point 2-4″ above said user's desktop surface, for improved usage of the onboard keyboard and improved safety from drink spill damage.

34. The stand of claim 1 wherein:
a. said one or two primary support members and said one or two cross-members, when assembled, have a concave shape to their bottom edge to sit securely on a users lap. and
b. said one or two primary support members and said one or two cross-members have rounded bottom corners for comfort against a users lap, and
c. said one or two cross-members have perpendicular upward protruding feet at both sides to prevent said laptop computer from sliding off of said stand.
